(19) United States
(12) Patent Application Publication
(10) Pub. No.: US 2026/0167539 A1
(43) Pub. Date: Jun. 18, 2026

(54) METHOD FOR TREATING A PFAS-CONTAMINATED LIQUID MEDIUM

(71) Applicant: SPUMA, Paris (FR)

(72) Inventors: Hugo CARRONNIER, PARIS (FR); Eric BRANQUET, BOULOGNE-BILLANCOURT (FR)

(21) Appl. No.: 18/717,668

(22) PCT Filed: Nov. 27, 2023
(86) PCT No.: PCT/EP2023/083221

§ 371 Date: Jun. 7, 2024

(30) Foreign Application Priority Data
Nov. 28, 2022 (FR) 2212449

(51) Int. Cl. C02F 1/74; C02F 1/00; C02F 1/28; C02F 1/56; C02F 1/66; C02F 1/72

(52) U.S. Cl. CPC C02F 1/74; C02F 1/008; C02F 1/283; C02F 1/56; C02F 1/66; C02F 1/722

(57) ABSTRACT

A method for treating an aqueous liquid medium contaminated by at least one per- or polyfluoroalkyl substance. This method includes a step of placing the liquid medium in contact with ovalbumin, then a step of removing from the liquid medium, by the flotation technique, the ovalbumin bonded to said substance.

The present invention lies in the general field of the purification of water, more precisely water contaminated by per- and polyfluoroalkyl type substances.

More particularly, the present invention relates to a method for treating an aqueous liquid medium contaminated by at least one per- or polyfluoroalkyl substance, in particular by a mixture of per- and polyfluoroalkyl substances, in view of removing this or these substance(s) therefrom.

Water pollution has become a major concern of the population and legislators.

Many water depollution techniques have emerged, and the panel of polluting molecules targeted by these techniques has expanded, regularly taking into account new so-called emerging pollutants.

Per- and polyfluoroalkyl substances (collectively referred to by the acronym PFAS, or “Per- and Poly-Fluorinated Alkyl Substances”), defined in particular in the publication by Buck et al., 2011, Integr Environ Assess Manag, 7(4): 513-541, are synthetic organofluorine compounds including one or more per- or polyfluoroalkyl groups. PFAS are in particular characterized by the presence of at least one methyl or methylene group of which the carbon atom is totally fluorinated, that is to say of at least one perfluorinated methyl group (—CF₃) or one perfluorinated methylene group (—CF₂—). Due to the strength of the carbon-fluorine bonds, these substances have a very high chemical stability.

The particular properties of PFAS, in particular their ability to resist heat and their both hydrophobic and lipophobic character, giving them a behavior that repels water as well as oily substances, make them advantageous for many industrial applications. Since the 1950s, PFAS have thus been widely used in industry, and are in particular found in products as diverse as non-stick pans, waterproofings, stain-resistant coatings, foaming agents for extinguishing fires, etc.

Analytical surveys reveal the presence of PFAS in many reservoirs and receiving media such as ground water, surface water and soils, which leads to exposure to these substances for all living things, comprising microorganisms, flora, fauna and human beings. In particular, it has been demonstrated that contaminated water is the first route of exposure to PFAS for human beings (Hoffman et al., 20211, Environmental Health Perspectives, 119(1): 92-97). Moreover, toxicological studies show more and more frequently the toxicity of PFAS and their involvement in the occurrence of many pathologies, such as cancers, reduced immunity, reduced fertility, etc. The removal of PFAS from the environment, in particular from aqueous media, wherein they are often found, has therefore become an important public health issue, all the more difficult to address as PFAS are particularly stable in the environment, and are found in aqueous media in dissolved form.

Currently, no conventional water depollution technique makes it possible to satisfactorily remedy contamination by PFAS. Filtering on activated carbon filters, such as proposed in the prior art, along with the other conventional coagulation, flocculation, sedimentation, and filtering techniques, are in particular insufficiently effective and have a high energy cost.

It has been proposed by the prior art to implement, in order to remove PFAS from aqueous media, proteins capable of absorbing these substances. The medium to be purified is placed in contact with these proteins, then is separated therefrom, after they have performed the bonding of the PFAS contained in the medium.

By way of example, document US 2020/197903 describes a method for treating ground water or water generated by soil washing, and contaminated by PFAS, which uses an absorbent selected from plant proteins, globulins, albumins, edestin or lupin, forming a packed bed through which the water to be purified is brought to flow. Experiments described in this document show that the most effective absorbent for removing PFAS is the hemp protein extract, egg white powder being the least effective of the absorbents tested.

The publication by Turner et al., 2019, Chemosphere, 229: 22-31 also describes a method for decontaminating water contaminated by PFAS, using a hemp protein extract or various other protein extracts, of which soy protein powder and egg protein powder. The work described in this document indicates that by far the most efficient protein extracts are those from hemp and from soy.

However, none of these methods makes it possible to obtain satisfactory PFAS reduction rates at reasonable costs. Currently, it is thus still extremely difficult and costly to remedy the contamination of aqueous media by PFAS.

The aim of the present invention is to overcome the drawbacks of the methods proposed in the prior art for decontaminating aqueous media polluted by PFAS, in particular the drawbacks described above, by proposing such a method that is effective, in terms of reliability and efficiency, for performing the specific removal of pollutants of the family of PFAS from aqueous media, and not very expensive to implement.

Additional objectives of this invention are that this method is easy to perform on the industrial scale, including for the treatment of large volumes of contaminated liquid. Another aim of the invention is for this method to be as environmentally friendly as possible, and produce little waste.

To this end, it is proposed according to the invention a method for treating an aqueous liquid medium contaminated by at least one per- or polyfluoroalkyl substance, in view of removing this substance therefrom. This method comprises a step of placing the liquid medium in contact with ovalbumin, so as to obtain the binding between the ovalbumin and said substance, then a removal step of removing the ovalbumin, at least part of which is then in a form linked to the per- or polyfluoroalkyl substance, from the liquid medium. This removal step is performed by flotation.

It was discovered by the present inventors that the combined implementation of ovalbumin, as a protein capable of binding PFAS, and of the particular technique of flotation separation, makes it possible to achieve particularly high reduction rates of the amount of PFAS present in the aqueous liquid medium treated, and this for a wide spectrum of PFAS, comprising in particular the PFAS the most frequently found in the environment, such as 6:2 fluorotelomer sulfonamide alkylbetaine (6:2 FTAB), and those described as having a particular toxicity for living organisms, such as perfluorooctane sulfonic acid (PFOS) and perfluorooctanoic acid (PFOA), these two substances further being the most regulated in the world. This reduction rate is particularly high for PFAS with medium to long alkyl chains, that is to say with chains comprising at least 6 carbon atoms, and particularly for PFAS of the sulfonic acid type. Such a performance is all the more surprising as the prior art, as illustrated by the aforementioned documents, diverts from the use of ovalbumin for such an application, to the benefit of other proteins such as hemp seed proteins, having much greater affinities for PFAS than ovalbumin. However, when the use of ovalbumin is combined with the flotation technique, which takes advantage of the property of ovalbumin to generate foam during the implementation of the flotation technique, the ability of ovalbumin to extract PFAS from an aqueous medium is potentialized, at a level that nothing in the prior art suggested. The level of performance of the method according to the invention is in particular sufficient for performing the removal of the PFAS in solution in liquid media in concentrations ranging from a few nanograms to more than one hundred of micrograms per liter, such as they are typically encountered in the environment in surface and ground water, but also in concentrated effluents.

Apart from the fact that it is particularly efficient, the method according to the invention is easy and quick to implement, by means of equipment and techniques that are simple and commonly available in wastewater treatment facilities. The method may in particular be implemented in wastewater treatment plants, by means of equipment that is pre-existing therein.

By way of example, for the particular case of perfluorooctane sulfonic acid, a removal rate of close to 100% may be achieved within less than one hour.

The cost of implementing the method according to the invention is advantageously reduced, in particular due to the low cost of the raw materials that it uses, more precisely of ovalbumin, main constituent of egg white, of which the supply in large amounts is furthermore easy, in liquid or powder form, in specialist food plants, such as egg breaking plants. Its energy cost is also low. In particular, all of its steps are preferably advantageously implemented at room temperature.

The method according to the invention, which requires for its implementation nothing more than ovalbumin, a biodegradable protein, and gas, in particular air, is furthermore environmentally friendly.

The method according to the invention may in particular be used for treating an aqueous liquid medium contaminated by a plurality of per- and polyfluoroalkyl substances, in view of removing all of these substances.

The method according to the invention may further meet one or more of the following features, implemented alone or in each of their technically operational combinations.

The step of placing the liquid medium in contact with ovalbumin is preferably carried out during a sufficient time to ensure a maximum interaction of the ovalbumin with the molecules of the per- and polyfluoroalkyl substance(s) (PFAS) contained in the liquid medium. In particular implementations of the invention, the step of placing the liquid medium to be purified in contact with ovalbumin is performed for a period between 5 and 60 minutes, in particular between 5 and 30 minutes. Preferably, this step is performed with stirring of the liquid medium to be purified, so as to ensure therein a homogeneous distribution of the ovalbumin.

The step of placing the liquid medium in contact with ovalbumin comprises in particular introducing, into the liquid medium, a suitable amount of ovalbumin so as to ensure the capture of all of the PFAS molecules contained in the liquid medium. Preferably, this amount is between 0.05 and 10 grams, in particular between 0.08 and 8 grams, per liter of the liquid medium. Thus, in particular embodiments of the invention, the step of placing the liquid medium in contact with ovalbumin comprises introducing, into the liquid medium, an amount of ovalbumin between 0.05 and 10 g/l, for example between 0.08 and 8 g/l.

The ovalbumin can be introduced into the liquid medium in solid or liquid form, in pure or substantially pure form, or within a complex mixture containing it. In preferred embodiments of the invention, in particular from the point of view of cost and of ease of implementation, for the step of placing the liquid medium in contact with ovalbumin, the ovalbumin is introduced into the liquid medium contained in egg white. As indicated above, egg white, of which ovalbumin is the main component, offers the advantage of high availability in large amounts and at low cost. It falls within the skills of the person skilled in the art to determine the suitable amount of a mixture containing ovalbumin to be introduced into the liquid medium to be purified, according to the ovalbumin concentration in this mixture.

By way of example, egg white powder, obtained by dehydrating egg white, typically containing approximately 76% by weight of ovalbumin, can be introduced into the liquid medium to be purified in a concentration between 0.1 and 10 g/l. Such a powder has in particular the advantage of being easy to use.

Thus, the method according to the invention preferably comprises introducing egg white into the liquid medium to be purified. To this end, the egg white may be in its natural form, in powder form, such as obtained by dehydrating egg white, or in the form of a liquid solution obtained by dissolving such a powder in a liquid vehicle, preferably in water.

In particular embodiments of the invention, the liquid medium has a pH between 6 and 6.8, for example between 6.4 and 6.5. A pH in such a range of values advantageously favors the binding forces that are created in the medium between the PFAS molecules and the ovalbumin molecule. Thus, the method according to the invention preferably comprises a step of measuring the pH of the liquid medium, and, if necessary, a step of adjusting this pH in the aforementioned range of values. Such an adjustment may be performed in any conventional way for the person skilled in the art, in particular by introducing into the liquid medium a suitable amount of a buffer solution, such as a disodium phosphate and monosodium phosphate buffer solution, of a base such as sodium hydroxide or of an acid such as hydrochloric acid. These steps of measuring, and if applicable adjusting, the pH, may be performed prior to introducing ovalbumin into the liquid medium, or subsequently to this introduction, as well as at any moment during the method, preferably at regular intervals so as to maintain the pH in its optimal range of values throughout the implementation of the method.

The method according to the invention may comprise introducing into the liquid medium, in addition to ovalbumin, any other compound likely to improve the performance of the method for removing the PFAS that are contained therein. It may in particular comprise introducing into the liquid medium, before, concomitantly, or after, the introduction of ovalbumin, one or more other substances capable of binding the PFAS, and/or foaming. Preferably, for better economy and ease of implementing the method, ovalbumin, or the egg white containing it, is the only active product introduced into or placed in contact, in any way, with the liquid medium to be purified.

The flotation technique, also known as foam fractionation, is well known per se. It consists in selectively floating a product that is in suspension in a liquid medium by means of a foam formed by injecting gas, in particular air, into this medium.

The separation step of the method according to the invention thus comprises injecting gas into the liquid medium containing ovalbumin, of which at least part of the molecules are complexed therein with one or more PFAS, so as to form bubbles therein. The gas used is preferably air. Other gases, such as dinitrogen or dioxygen for example, may also be used, alone or in combination, these gases preferably being selected to be chemically inert with respect to ovalbumin and with respect to the PFAS.

Preferably, the injection of gas is performed by a gas diffuser disposed in the bottom part of a reservoir containing the treated medium, so as to generate an upflow of gas bubbles in the latter. This diffuser then has a pore size between 10 and 100 μm, preferably a pore size between 10 and 50 μm, in particular between 10 and 30 μm, so as to form gas bubbles of the same diameter.

In alternative embodiments of the invention, particularly adapted to a continuous and industrial implementation, the injection of gas into the liquid medium is performed by introducing into the latter water saturated with microbubbles of gas, essentially of air, known as white water.

The ovalbumin molecules present in the liquid medium accumulate on the gas bubbles injected into this medium, and rise with them to the surface of the liquid medium, at which a foam forms containing the ovalbumin molecules as well as the PFAS molecules that are bound thereto, thereby performing their separation of the liquid medium, which is thus purified.

In particular embodiments of the invention, the step of flotation removal of the method comprises:
injecting gas into the liquid medium for a period between 5 and 60 minutes, preferably between 5 and 40 minutes, so as to form a foam at the surface of the liquid medium, this foam containing ovalbumin and the per- and polyfluoroalkyl substance(s) initially contained in the liquid medium, at the very least a significant proportion of this or these substance(s),
and collecting the foam thus formed, so as to separate it from the liquid medium which is thereby purified.

The gas flow to be injected into the liquid medium depends on the volume/surface ratio of the liquid medium to be purified. It is within the skills of the person skilled in the art to determine the suitable flow of gas for each given facility. The flow of gas, in particular of air, injected into the liquid medium is for example between 0.1 and 10 l/min, in particular between 0.1 and 1 l/min.

Collection of the foam formed at the surface of the liquid medium may be performed by any means known to the person skilled in the art. It may for example be performed by overflowing, by overspilling, by a skimmer system or else by suction.

In a very advantageous way, the method according to the invention produces a low amount of waste.

The collected foam may be subjected to a destructive treatment, that may be of any type. Thus, the method according to the invention may comprise a step of treating the collected foam by thermal degradation, by sonolysis, by plasma, etc.

As indicated above, combining ovalbumin and the flotation technique makes it possible to achieve particularly high PFAS removal rates over short periods, with a minimal number of operations to be performed and at a low cost. The flotation technique is in particular much more effective, for separating PFAS-loaded ovalbumin from the liquid medium, than other conventional separation techniques, such as centrifugation or acid centrifugation and coagulation.

Ovalbumin for its part is much more effective than the other proteins in combination with the flotation technique, including than the proteins described in the prior art as having a much better ability to bind with PFAS. Without prejudging the phenomena underlying such a performance, it can be assumed that it is at least partly due to a synergy between two properties of ovalbumin, of which the invention advantageously takes advantage to specifically extract the pollutants of the PFAS family from a liquid medium, in particular of aqueous type, which contains them, namely the affinity of ovalbumin for this class of chemical substances and its capacity to generate foam. This synergistic effect was however unexpected, and its magnitude even more so.

The method according to the invention can be implemented by means of any conventional device, comprising in particular a reactor, wherein is placed the liquid medium to be purified, a means for supplying this reactor with ovalbumin, a diffuser of gas in the liquid medium, and a means for collecting the foam formed, as well as optional means for measuring the pH, stirring, etc. Advantageously, on the industrial scale, the method can be implemented continuously, by means of a facility comprising a system generating microbubbles in a so-called bubbling tank wherein the liquid medium to be treated is driven continuously, either in the form of white water injected into the flow of liquid medium to be treated or from one or more air diffusers positioned in the bottom part of this flow. In such a configuration, ovalbumin is preferably injected into the flow of liquid medium to be treated upstream of the bubbling tank, by means of a suitable system, for example, either by a mixing bowl, or in a mixing tank, or any other system allowing a sufficient contact time between ovalbumin and the liquid medium before the latter reaches the bubbling tank. The foam that accumulates at the surface of the bubbling tank, containing the PFAS, can be recovered by a surface scraper system circulating counterflow to the flow of liquid medium, then be removed, for example by means of an overflow, into a discharge hopper, before being recovered in a suitable container.

The aqueous liquid medium to which the method according to the invention is applied may be of any type. Preferably, in the context of applying the method to the management of polluted soils and sites, in particular to the treatment of contaminated water, the aqueous liquid medium is ground water, surface water, water from soil washing, or wastewater.

Thus, the method according to the invention may optionally comprise a preliminary step of pumping the liquid medium to be purified out of a water table, or of a residual water on the surface of the ground.

In particular embodiments of the invention, representative of such a phreatic water or contaminated surface water typically found in the environment, the liquid medium to which the method of the invention is applied contains 0.1 to 2,000 μg/l of per- or polyfluoroalkyl substance(s). This means a total PFAS concentration in the medium.

The method according to the invention optionally comprises a preliminary step of measuring the PFAS concentration in the liquid medium to be purified. Such a measurement may for example be performed according to the method described in the standard ASTM D7979-2020.

The method according to the invention makes it possible to remove from aqueous media PFAS belonging to all of the listed categories thereof, in particular belonging to the four major subclasses representative of all of the categories of PFAS, namely perfluoroalkyl sulfonic acids, perfluoroalkyl carboxylic acids, perfluoroalkyl sulfonamides and fluorotelomer sulfonic acids. It is the most efficient for removing perfluoroalkyl sulfonic acids and perfluoroalkyl carboxylic acids, in particular of the type with medium to long chains, that is to say of which the alkyl group includes 6 or 7 or more carbon atoms.

In particular embodiments of the invention, the per- or polyfluoroalkyl substance contained in the liquid medium to be purified, and that the method according to the invention aims to remove, comprises an alkyl chain having 6 or more, in particular 7 or more, carbon atoms, and belongs to the subclass of perfluoroalkyl sulfonic acids or perfluoroalkyl carboxylic acids. The method according to the invention is in particular highly effective for removing per- or polyfluoroalkyl substances of the perfluoroalkyl sulfonic acid type comprising a C6 or more alkyl chain.

Preferably, the liquid medium to be purified mostly contains per- and polyfluoroalkyl substances of the perfluoroalkyl sulfonic acid and/or perfluoroalkyl carboxylic acid types, of which the alkyl group comprises at least 6 carbon atoms, preferably at least 7 carbon atoms, that the method according to the invention aims to remove.

The method according to the invention also makes it possible to remove from the liquid media per- or polyfluoroalkyl substances with shorter alkyl chains.

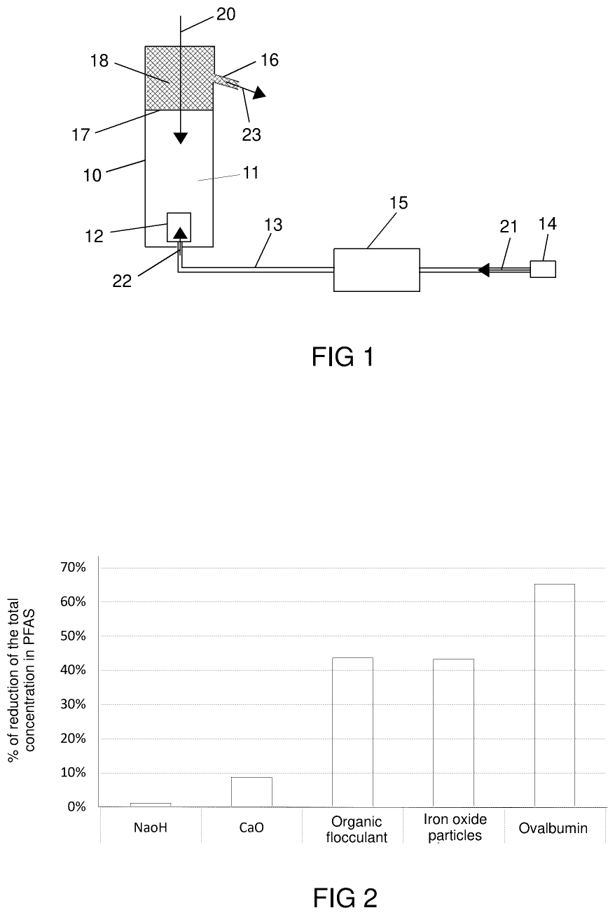

The features and advantages of the invention will become more apparent in light of the examples of implementations below, provided purely by way of illustrative and non-limiting examples of the invention, with the support of FIGS. 1 to 3, wherein:

FIG. 1 schematically represents one example of device used for implementing a method according to the invention, and the main steps of this method.

FIG. 2 shows a graph representing the % of reduction of the total PFAS concentration in a sample of water contaminated by PFAS, after placing it in the presence of various conventional flocculants/coagulants (NaOH, CaO, an organic flocculant, or iron oxide particles), or of ovalbumin, the separation being performed by filtering.

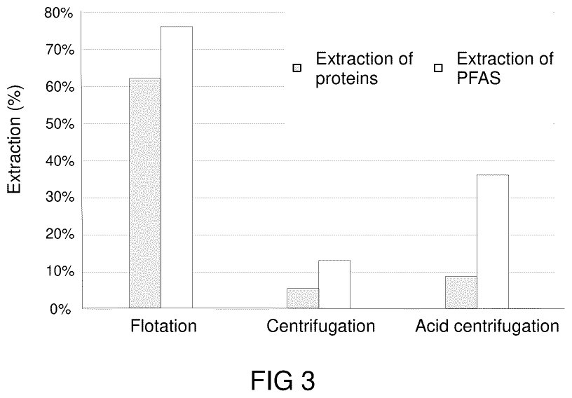

FIG. 3 shows a graph representing the extraction rate (in %) respectively of PFAS and of proteins, by various methods (flotation, centrifugation, acid centrifugation) implemented after placing a sample of water containing PFAS in contact with ovalbumin, for 15 min.

An example of a device for implementing a method for purifying liquid media contaminated by PFAS according to the invention, which has in particular been used for the experiments described below, on the laboratory scale, is shown in FIG. 1. This device comprises a reactor 10, preferably made of glass, containing the volume of liquid medium to be purified 11. In its bottom part, the reactor 10 contains a bubbler 12, preferably made of sintered ceramic. This bubbler is connected, by a pipe 13, to a compressed gas, in particular compressed air, generator 14. A pressure regulator 15 is mounted on the pipe 13, between the compressed gas generator 14 and the bubbler 12. In its opposite top part, the reactor 10 is provided with a pouring spout 16.

In order to implement the method according to the invention, comprising a step of flotation separation (or foam fractionation), the following steps are performed. In a first step, ovalbumin in a suitable amount is introduced into the reactor, in the liquid medium to be purified 11, as indicated in 20 in the figure. After a predetermined contact time, compressed gas is injected into the pipe 13, as indicated in 21 in the figure, up to the bubbler 12, as indicated in 22. The bubbler 12 then diffuses fine bubbles (not represented in the figure) into the liquid medium 11. It is formed in the reactor 10, above the surface 17 of the liquid, a foam 18 loaded with ovalbumin-PFAS complex. This foam escapes from the reactor 10 naturally, as indicated in 23 in the figure, via the pouring spout 16, and is recovered. At the end of these steps, the liquid medium remaining in the reactor is advantageously purified of the PFAS that it initially contained.

### A/EXAMPLE 1—STUDY OF THE EFFICIENCY OF THE METHOD ACCORDING TO THE INVENTION

### A.1/General Material and Methods

The equipment used comprises:
borosilicate glassware,
a Mettler Toledo AG SevenEasy® pH-meter,
a Mettler Toledo balance with a precision of 10⁻⁴ g,
a Mettler AE163 precision balance with a precision of 10⁻⁵ g,
precision pipettes with a precision of 10-100 μl,
a 10510 Bioblock Scientific magnetic stirrer.

Two types of contaminated water samples are used: a collected sample and a doped sample.

The collected contaminated water sample comes from a stock of runoff water collected on the site of an industrial fire wherein agents forming a floating film (AFFF) were used. The sample was kept in a 50 L sealed bag-in-a-box. Its initial pH was 8.24. Table 1 presents the list and the concentrations of the PEAS measured in this sample before treatment.

TABLE 1
list and concentrations of PFAS in the collected water sample

| | Concen- |
|---|---|
| | tration |
| Substance | (μg/l) |
| Ammonium 4-trifluoromethylperfluoroheptanoate (P4MHpA) | 0.019 |
| Ammonium 5-trifluoromethylperfluoroheptanoate (P5MHpA) | 0.024 |
| Ammonium 6-trifluoromethylperfluoroheptanoate (P6MHpA) | 0.042 |
| Perfluoro-1-methyl-heptanesulfonate (P1MHpS) | 0.055 |
| Perfluoro-3-methyl-heptanesulfonate (P3MHpS) | 0.27 |
| Perfluoro-4-methyl-heptanesulfonate (P4MHpS) | 0.48 |
| Perfluoro-5-methyl-heptanesulfonate (P5MHpS) | 0.99 |
| Perfluoro-6-methyl-heptanesulfonate (P6MHpS) | 1.7 |
| Potassium 3,5-di(trifluoromethyl)perfluorohexanesulfonate | 0.094 |
| (P35DMHXS) | |
| Potassium 4,5-di(trifluoromethyl)perfluorohexanesulfonate | 0.062 |
| (P45DMHXS) | |
| Potassium 5,5-di(trifluoromethyl)perfluorohexanesulfonate | 0.122 |
| (P55DMHXS) | |
| Heptafluorobutyric acid (PFBA) | 0.414 |
| Nonafluoropentanoic acid (PFPeA) | 0.109 |
| Undecafluorohexanoic acid (PFHxA) | 0.67 |
| Perfluoroheptanoic acid (PFHpA) | 0.209 |
| Perfluorooctanoic acid (PFOA) | 0.8137 |
| Perfluorononanoic acid (PFNA) | 0.01 |
| Perfluorodecanoic acid (PFDA) | 0.01 |
| Perfluorobutane sulfonic acid (PFBS) | 0.7 |
| Perfluorohexane sulfonic acid (PFHxS) | 2.95 |
| Perfluoro-n-undecanoic acid (PFUnA) | 0.01 |
| Perfluorooctane sulfonic acid (PFOS) (containing | 13.163 |
| traces of LPFHxS and LPNFS) | |
| Tricosafluorododecanoic acid (PFDoA) | 0.01 |
| Total | 22.9267 |

The doped water sample was prepared from distilled water and the 10 pure PFAS compounds obtained from Sigma-Aldrich listed in Table 2, with the indicated concentrations.

TABLE 2
list and concentrations of PFAS in the doped water sample

| | | Concentration |
|---|---|---|
| Substance | CAS No. | (μg/L) |
| Perfluorononanoic acid (PFNA) | 375-95-1 | 35.5 |
| Perfluorooctane sulfonic acid (PFOS) | 1763-23-1 | 374 |
| (solution at 40%) | | |
| Perfluorooctanoic acid (PFOA) | 335-67-1 | 106 |
| (solution at 10 mg/l) | | |
| Perfluorohexanoic acid (PFHxA) | 307-24-4 | 187 |
| Perfluorobutane sulfonic acid (PFBS) | 375-73-5 | 25.8 |
| Heptafluorobutyric acid (PFBA) | 375-22-4 | 740 |
| Perfluoro(2-methyl-3-oxahexanoic) acid | 13252-13-6 | 325 |
| (GenX) | | |
| Perfluoroheptanoic acid (PFHpA) | 375-85-9 | 7.7 |
| Tricosafluorododecanoic acid (PFDoA) | 307-55-01 | 2.99 |
| Perfluorodecanoic acid (PFDA) | 335-76-2 | 33.3 |

The PFAS concentrations of the initial samples and samples after experiments were determined according to the method ASTM D7979-2020 (quantification limit of 50 ng/l).

The content of proteins present in the samples was estimated by measuring the total nitrogen according to the method described in the standard NF EN 25663. For the experiments studying the impact of the pH, the samples were prepared in 300 ml of distilled water. A mother solution was produced by dissolving powdered egg white, as described above, by magnetic stirring. The various pH were obtained from a disodium phosphate and monosodium phosphate buffer solution:
27.6 g of sodium dihydrogen phosphate dissolved in 230 ml of deionized water,
35.1 g of disodium hydrogen phosphate dissolved in 740 ml of deionized water, with adjustment to the various pH by concentrated sodium hydroxide NaOH or hydrochloric acid HCl, and addition of deionized water qsp 1 l.

### A.2/Experiment 1—Efficiency of Ovalbumin for the Adsorption of PFAS

The efficiency of ovalbumin for extracting PFAS was evaluated on 1 l of collected contaminated water sample described above.

Fresh egg whites were used as sources of ovalbumin. 10 ml of fresh egg whites, with a content of 11% of proteins, were introduced into 1 l of sample to be decontaminated. The generation of foam was ensured by a rigorous manual stirring for 50 s; then the foam was collected manually using a spatula, and the remaining liquid medium was analyzed.

By way of comparison, various flocculants/coagulants frequently used in water treatment methods were implemented in the same way for extracting PFAS in 1 l of collected contaminated water sample. These reagents are described in Table 3.

TABLE 3
Reagents used

| | Concentration | | |
|---|---|---|---|
| Flocculant/coagulant | (/I) | | Details |
| Sodium hydroxide | 20 | ml | industrial soda lye at 30% |
| NaOH | | | |
| Calcium oxide CaO | 5 | g | Calcium oxide (CaO >99% in |
| | | | powder), supplier Sigma-Aldrich |
| Iron oxide (Fe₃O₄) | 1 | g | HYMAG'IN - Type: HHM-2102 - |
| magnetic particles | | | PAM2433 |
| Organic flocculant | 3 | ml | EM 640 - CT (FLOPAM ®), |
| | | | supplier SNF Floerger |

The organic flocculant used had a high molecular mass, a linear structure and a cationic charge.

All of the samples were beforehand homogenized with a magnetic stirrer and filtered on a 25×5 cm column of sand calibrated to 0.5 mm before treatment, then a second time after each test, in order to separate the deposited solids and the flocs from the liquid medium. For each sample, a new sand filter was used to prevent cross contamination.

For the test aiming to quantify the adsorption methods with magnetic particles, 1 g of magnetic particles was added directly in the contaminated water. The sample was placed in a rotary stirrer for 24 h. The particles were separated after a contact time of 24 h using a magnetized disc.

The results obtained are shown in FIG. 2. The reduction rates obtained are more precisely 1% for NaOH, 9% for CaO, 44% for the organic flocculant, 43% for the iron oxide particles, and 65% for ovalbumin. It is noted that among the various treatments tested, the one using ovalbumin has the best reduction rate.

### A.3/Experiment 2—Efficiency of the Flotation Separation Combined with the Use of Ovalbumin

In this experiment, various separation techniques (flotation, centrifugation, acid centrifugation) were tested after placing 1 l of doped water sample as described above, containing 1.83 mg/l of PFAS, in contact with ovalbumin for 15 min.

Ovalbumin was used in egg white powder form acquired from the distributor Cerf Dellier (Ref. P2055, brand Patisdecor). This powder was mixed with distilled water using a magnetic stirrer to create a homogeneous liquid solution before introducing it into the reactor. The egg white was introduced into the doped water sample at a concentration of 1 g/l.

The following parameters were applied for the flotation:
air flow for the bubbling: 0.3 l/min,
bubbling time: 40 min.

The liquid medium remaining after collecting the foam was subjected to analysis of its concentration in PFAS on the one hand, and in protein (of which ovalbumin) on the other hand.

For the separation by centrifugation, the sample containing the PFAS and the ovalbumin was centrifuged for 15 min., with a speed of 4,200 rpm and an acceleration of 8 g. The supernatant was collected for analysis.

For the separation by acid centrifugation, 5 g of trichloroacetic acid (98% in powder) was added to the sample containing the PFAS and the ovalbumin.

Centrifugation was subsequently applied for 15 min., with a speed of 4,200 rpm and an acceleration of 8 g. The supernatant was collected for analysis.

The results obtained are shown in FIG. 3. It is observed that the flotation, or foam fractionation, method that consists in injecting microbubbles of air into the medium in order to make the ovalbumin and the associated PFAS rise to the surface of the liquid, appears to be the most effective of the three methods tested.

The liquid medium obtained after the flotation step was subjected to a more precise analysis targeting particular PFAS. For these substances, the reduction rates obtained are indicated in Table 4.

TABLE 4
Reduction rates of each substance

| PFAS | PFNA | PFDA | PFDoA | LPFHxS | PFOS | LPFNS |
|---|---|---|---|---|---|---|
| reduction % | 92 | 89 | 71 | 83 | 92 | 100 |

A good performance of the method according to the invention for all of these substances is observed.

### A.4/Experiment 3—pH of the Liquid Medium

This experiment was performed as described in Experiment 2 above, with the exception of the egg white concentration used, which was 1.6 g/l. The pH of the sample was further adjusted to various values, between 5.2 and 7.6. The results obtained, in terms of amount of protein extracted from the medium (in mg of nitrogen per 1) depending on the pH, are indicated in Table 5.

TABLE 5
Amount of proteins extracted from a water
sample containing PFAS by a method
according to the invention,
for various pH of the sample.

| | | | | | | | |
|---|---|---|---|---|---|---|---|
| pH | 5.2 | 5.6 | 6 | 6.4 | 6.8 | 7.2 | 7.6 |
| Proteins | 184 | 183 | 253 | 279 | 240 | 200 | 175 |
| extracted | | | | | | | |
| (mgN/I) | | | | | | | |

It is observed that the amount of proteins extracted from the liquid medium is high for all of the pH tested, the range of 6 to 6.8 making it possible to obtain the best extraction rates.

### B/EXAMPLE 2—COMPARATIVE STUDY OF VARIOUS PROTEINS

### B.1/Material and Methods

The equipment used comprises:
borosilicate glassware,
a Mettler Toledo AG SevenEasy® pH-meter,
a Mettler Toledo XP6002 SDR balance, d=0.01/0.1 g,
a Mettler AE163 precision balance, d=0.01/0.1 mg,
micropipettes (EASY 40+, 10-100 μL) with tips (ULTRAFINE® POINT, VWR),
a stainless steel metal rod with a porous stone for diffusing air to carry out the bubbling.

Doped water samples were prepared by diluting in distilled water, under magnetic stirring, pure PFAS compounds distributed by Sigma-Aldrich, CPA Chem, Alfa Aesar and Manchester Organic Limited, according to the composition described in Table 6.

TABLE 6
list and concentrations of PFAS in the doped water samples

| | | Concentration |
|---|---|---|
| Substance | CAS No. | (μg/L) |
| Perfluorooctane sulfonic acid (PFOS) | 1763-23-1 | 12 |
| (Sigma-Aldrich, solution at 40%) | | |
| Perfluorooctanoic acid (PFOA) (CPA | 335-67-1 | 4 |
| Chem, solution of 10 mg/l) | | |
| Perfluorohexanoic acid (PFHxA) | 307-24-4 | 11 |
| (Sigma-Aldrich, liquid form ≥97%) | | |
| Perfluorohexane sulfonic acid (PFHxS) | 355-46-4 | 0.2 |
| Perfluoroheptane sulfonic acid (PFHxS) | 21934-50-9 | 0.3 |
| Perfluorobutane sulfonic acid (PFBS) | 375-73-5 | 14 |
| (LGC, liquid form, 97%) | | |
| Perfluoro(2-methyl-3-oxahexanoic) acid | 13252-13-6 | 10 |
| (GenX) (Manchester Organics Limited, | | |
| liquid form 97%) | | |
| Capstone product B (6:2 FTAB) | 34455-29-3 | 15 |
| (LGC, solid form ≥99%) | | |
| Perfluorodecanoic acid (PFDA) | 335-76-2 | 1 |
| (Alfa Aesar, solid form 97%) | | |

The pH of the samples was adjusted and maintained at 6.4 using a disodium phosphate and monosodium phosphate buffer.

The proteins implemented were the following:
ovalbumin (OVA), in the form of powdered egg white of protein purity 76% (Myprotein®),
bovine serum albumin (BSA), purity 96% (Fischer Scientific),
native chicken lysozyme protein (LYS), purity 95% (abcam),
powdered hemp seed protein (CHA), purity 54% (Myvegan®),
soy protein isolate (SOJ), purity 90% (Myvegan®).

For each protein, 1 l of sample doped with PFAS was used, with a concentration in the sample of 1 g/l of each of the products above. For OVA, a concentration of 10 g/l was also studied (“OVAb”).

After 5 min of contact between the protein and the sample to be purified, the bubbling was performed using a bubbling stone of pore sizes between 10 and 100 μm, releasing air with a flow rate of 0.3 l/min for 40 min, while evacuating the foam produced as and when it is formed.

By way of control, 1 l of doped sample without protein was subjected to the same operations.

The initial samples (not treated) as well as those recovered after treatment were analyzed according to the method EPA 537.1, detailed in the publication by Kaboré and al., 2018, Science of the Total Environment, 616-617, 1089-1100, for the quantification of each of the PFAS present, with a variable quantification limit according to the compounds, between 0.53 and 2.4 ng/L.

### B.2/Results

The results obtained are shown in Table 7.

TABLE 7
reduction rates of the PFAS at the end of a method
comprising placing a sample of water doped with PFAS
in contact with a protein then flotation separation.

| Substance\ | | | | | | | |
|---|---|---|---|---|---|---|---|
| Protein | - | BSA | CHA | LYS | SOJ | OVA | OVAb |
| PFHxA | 3% | 57% | 9% | 17% | 9% | 35% | 49% |
| PFOA | 4% | 72% | 18% | 53% | 14% | 99% | - |
| PFDA | 6% | 8% | 47% | 80% | - | 94% | 94% |
| PFBS | 7% | 44% | 10% | 16% | 7% | 23% | 43% |
| PFHxS | 13% | 54% | 16% | 52% | 16% | 100% | 100% |
| PFHpS | 12% | 64% | 37% | 63% | 32% | 100% | 100% |
| PFOS | 8% | 54% | 57% | 77% | 58% | 99% | - |
| GenX | 4% | 84% | 13% | 19% | 8% | 73% | - |
| 6:2 FTAB | 5% | 97% | 28% | 33% | 20% | 96% | 96% |

It is noted that ovalbumin OVA makes it possible to obtain the best reduction rates for most of the PFAS studied. For FHxA (perfluorohexanoic acid), PFBS (perfluorobutane sulfonic acid) and GenX (Perfluoro(2-methyl-3-oxahexanoic) acid), its efficiency is a little less than that of BSA, and it is equivalent for 6:2 FTAB. For these substances, the reduction rate nevertheless remains satisfactory, and may be improved by increasing the ovalbumin concentration implemented. Compared with soy or hemp proteins, recommended in the prior art, ovalbumin is much superior.

Globally, by considering all of the PFAS, the method using ovalbumin, in accordance with the invention, is by far the most efficient.

### C/EXAMPLE 3—SIZE OF THE BUBBLES

Water samples were doped with 15 PFAS compounds (PFHxA, PFHpA, PFOA, PFNA, PFDA, PFBS, PFPeS (perfluoropentanesulfonic acid), PFHxS, PFHpS (perfluoroheptanesulfonic acid), PFOS, PFNS (perfluorononanesulfonic acid), PFDS (perfluorodecanesulfonic acid), GenX, 6:2 FTAB and 6:2 FTS (6:2-fluorotelomer sulfonic acid)) according to the initial concentrations figuring in Table 8, corresponding to a total concentration of 500 ng/L. The pH recorded was 6.30±0.20.

This experiment was performed as described in Experiment 2 above, with the exception of the egg white concentration used, which was 0.2 g/l, the bubbling time, which was 25 min, and the flow of air injected into the liquid medium, which was 3.0±0.2 l/min.

Three different bubbling stones, of respective porosity of 20 μm, 40-50 μm and 70-90 μm, were used to study the influence of the size of the bubbles on the efficiency of the treatment.

The results obtained, in terms of removal of each of the compounds, for each of the bubble sizes, are shown in Table 8.

TABLE 8
reduction rates of the PFAS depending on the size of the bubbles -
″Ini. conc.″ = initial concentration - ″Re.″ = reduction - ″<″ indicates a value lower
the quantification limit - ″>″ indicates that the reduction is greater than 99.9%,
due to a residual concentration after treatment that is lower than the quantification limit

| | Ini. conc. | Porosity 20 μm | | Porosity 40-50 μm | | Porosity 70-90 μm | |
|---|---|---|---|---|---|---|---|
| PFAS | (ng/l) | (ng/l) | Re. (%) | (ng/l) | Re. (%) | (ng/l) | Re. (%) |
| PFHxA | 30.9 | 5.5 | 82 | 7.2 | 77 | 8.4 | 73 |
| PFHpA | 30.1 | <2.5 | >99.9 | <2.5 | >99.9 | <2.5 | >99.9 |
| PFOA | 26.9 | <0.5 | >99.9 | <0.5 | >99.9 | <0.5 | >99.9 |
| PFNA | 21.8 | <2.5 | >99.9 | <2.5 | >99.9 | <2.5 | >99.9 |
| PFDA | 57 | <2.5 | >99.9 | <2.5 | >99.9 | <2.5 | >99.9 |
| PFBS | 34.4 | 17.4 | 49 | 18.8 | 45 | 20.3 | 41 |
| PFPeS | 30.1 | <2.5 | >99.9 | <2.5 | >99.9 | <2.5 | >99.9 |
| PFHxS | 23.8 | <2.5 | >99.9 | <2.5 | >99.9 | <2.5 | >99.9 |
| PFHpS | 27.2 | <2.5 | >99.9 | <2.5 | >99.9 | <2.5 | >99.9 |
| PFOS | 21.7 | <0.5 | >99.9 | <0.5 | >99.9 | <0.5 | >99.9 |
| PFNS | 35 | <2.5 | >99.9 | <2.5 | >99.9 | <2.5 | >99.9 |
| PFDS | 30.1 | <2.5 | >99.9 | <2.5 | >99.9 | <2.5 | >99.9 |
| Gen-X | 22.8 | <2.5 | >99.9 | <2.5 | >99.9 | <2.5 | >99.9 |
| 6:2 FTAB | 31.5 | <2.5 | >99.9 | <2.5 | >99.9 | <2.5 | >99.9 |
| 6:2 FTS | 30.0 | <2.5 | >99.9 | <2.5 | >99.9 | <2.5 | >99.9 |

These results confirm the efficiency of the method according to the invention for reducing PFAS concentrations in contaminated water. In the experimental conditions applied, the bubbles of size 20 μm are the most effective on all of the PFAS tested, which highlights the advantage of an extended contact surface with the ovalbumin. The bubbles of greater size, 40-50 μm and 70-90 μm, also show a noteworthy efficiency.

Specific observations concerning the short-chain compounds (PFBS, PFHxA) reveal that the smallest bubble size significantly improves the efficiency for removing these PFAS.

What is claimed is:

1. A method for treating an aqueous liquid medium contaminated by at least one per- or polyfluoroalkyl substance, comprising a step of placing said liquid medium in contact with ovalbumin then a removal step of removing said ovalbumin from said liquid medium, wherein said removal step is performed by flotation.

2. The method according to claim 1, wherein the step of placing said liquid medium in contact with ovalbumin is performed for a period between 5 and 60 minutes.

3. The method according to claim 1, wherein the step of placing said liquid medium in contact with ovalbumin comprises introducing into said liquid medium an amount of ovalbumin between 0.05 and 10 g/l.

4. The method according to claim 1, wherein, for the step of placing said liquid medium in contact with ovalbumin, the ovalbumin is introduced into said liquid medium contained in egg white.

5. The method according to claim 1, wherein said liquid medium has a pH between 6 and 6.8.

6. The method according to claim 1, wherein said removal step by flotation comprises injecting gas into said liquid medium for a period between 5 and 60 minutes so as to form a foam at the surface of said liquid medium, and collecting the foam thus formed.

7. The method according to claim 1, wherein said liquid medium contains 0.1 to 2,000 μg/l of per- or polyfluoroalkyl substance(s).

8. The method according to claim 1, wherein the per- or polyfluoroalkyl substance contained in said liquid medium comprises an alkyl chain having 7 or more carbon atoms.

9. The method according to claim 1, wherein the per- or polyfluoroalkyl substance contained in said liquid medium is a perfluoroalkyl sulfonic acid comprising an alkyl chain having 6 or more carbon atoms.

10. The method according to claim 1, wherein said liquid medium is ground water.

11. The method according to claim 1, wherein said liquid medium is surface water.

12. The method according to claim 1, wherein said liquid medium is water from soil washing.

13. The method according to claim 1, wherein said liquid medium is wastewater.
